(19) United States
(12) Patent Application Publication
(10) Pub. No.: US 2012/0003058 A1
(43) Pub. Date: Jan. 5, 2012

(54) MACHINE TOOL AND METHOD FOR PRODUCING GEARING

(76) Inventors: Wolfgang Hutter, Heidenheim (DE); Erhard Hummel, Schlierbach (DE)

(21) Appl. No.: 12/998,903

(22) PCT Filed: Dec. 16, 2009
(86) PCT No.: PCT/EP2009/009024

§ 371 Date: Sep. 6, 2011

(30) Foreign Application Priority Data
Dec. 19, 2008 (DE) 10 2008 063 858.7

(51) Int. Cl. B23F 9/10; B23P 15/14; B23C 1/12; B23F 21/12

(52) U.S. Cl. 409/26; 409/27; 29/893.35

(57) ABSTRACT

The invention concerns a machine-tool, in particular a milling machine Including
a machine frame;
a tool carrier mounted on the machine frame for receiving a tool;
a drive device for rotationally driving the tool in the tool carrier about a tool axis;
a receiving device (6) mounted on the machine frame (1), for receiving a workpiece (7);
a first rotary drive device for generating a first relative angular movement between the tool carrier and the receiving device and a second rotary drive device for generating a second relative angular movement between the tool carrier and the receiving device;
a translational drive device for generating a relative translation movement between the tool carrier and the receiving device along three axes;
a control device, which is designed in such a way that it enables to control the relative rectilinear movements between the tool carrier and the receiving device and the relative angular movement between the tool carrier and the receiving device substantially at the same time; wherein the tool is designed as a face or face circumference milling cutter and contains blades, which exhibit at least one partial contour of a gearing to be milled in the workpiece; wherein the external diameter of the blades is greater than the distance of two adjoining tooth flanks—tooth gap;

The invention is characterised in that the control device is designed, to move the tool in such a way through the region of the gearing to be produced that it is displaced globally along the tooth flank to be machined with equal or substantially equal distance with respect to the tooth gap base and/or with respect to the tooth tip of the gearing to be produced.

The present invention concerns a machine-tool, in particular a milling machine, as well as a method for milling toothed gears such as spur gears, contrate gears, worm gears and bevel gears.

Such particular toothed gears with external gearing can substantially be cut straight or helically. Spiral gearings are also known in particular with bevel gears, which means that the tooth flanks exhibit a longitudinal curvature in the form of an arc of a circle. Such bevel gears are also designated as spiral bevel gears. If an axis offset is provided, the bevel gears are then also called hypoid gears. Moreover, a plurality of additional gearings such as palloid, Klingelnberg and Gleason gearings are also known.

Substantially two methods, i.e. profile milling and hob machining, are utilised when producing external gearings. For profile milling the contour of the milling tool is applied directly to the workpiece, whereas the cutting movement is solely performed by the rotating milling tool, while the workpiece remains generally still. The workpiece is further rotated by a tooth pitch after the production of a tooth gap. Cutter heads and end mills in particular can find their application as tools.

Hob machining is utilised for economic production of straight or helically cut external toothed gears, such as spur gears, whereas the tool geometrically presents a single or multi-start worm which forms a worm drive with the workpiece to be toothed. the hob is driven during the milling cycle and moved mostly translationally during the milling cycle to produce the tooth gaps.

The so-called continuously indexing gearing process (continuous indexing process) is also involved in hob machining. To do so cutter heads are used as tools which exhibit on their front face a plurality of cutters exclusively pointing away in axial direction of the tool, which are arranged concentrically with respect to the external diameter of the milling head. Each of the cutters is designed in a different manner and hence exhibits an individual cutting geometry, so that each cutter only removes a certain fraction of a flank. The rotary contour of the tool, that is to say all the blades of the cutters, enables to obtain the tooth gap to be produced. In this method, the workpiece and the tool rotate with a certain regularity relative to one another, so that the tooth flanks of the tooth gap are formed by enveloping cuts of the individual blades.

The huge retrofitting required during the continuous indexing process proves disadvantageous since the rotation speeds of the workpiece and of the tool should be adjusted precisely depending on the gearing to be milled. The complicated operation of the milling cycle requires special purpose machines which are expensive to purchase.

In case of a so-called plunging method, also called individually indexing gearing method (individual indexing method), the tooth gaps are formed individually by plunging the tool. The workpiece remains still during the plunging cycle, then said workpiece is indexed further by a tooth pitch and the following tooth gap milled, until the bevel gear is completed. To do so, a milling head is used during continuous indexing process, whose cutters however have globally the same form and correspond to the profile of the tooth gap to be milled.

The major shortcoming of the methods described is that the tools are substantially suitable only for a given gearing. If special gearings are requested special mill cutters must also be prepared which are often not only expensive but also require a long delivery time in most cases.

During production of bevel gears with spiral gearing using a single indexing or continuous indexing process the external diameter of the tool depends on the requested gearing and in particular on the external diameter of the bevel gear to be produced. The reason is that in particular the radius of the longitudinal arc of a circle of the tooth flank substantially corresponds to half the diameter of the blades in relation to the rotational axis of the milling head. Thus, heavy tools and hence more powerful drive devices are necessary whereas due to the large weight of the tools reduced feeds and rotation speeds are possible, so that the machining times are lengthened. depending on the weight of the tools, the latter may not always be deposited in a tool magazine, but they need to be changed manually. Any manipulation for instance by industry robots is out of the question because of the excessive inertia loads during tool change. When producing relatively small toothed gears, the tools can still be mounted in the tool magazine of the machine-tool but in most cases their relatively large diameter requires a lot of space, so that significantly larger tool magazines should be made available.

The adjustment of the cutter heads during single and continuous indexing process proves particularly disadvantageous as regards the setting-up times since all the cutters should be arranged precisely in such a way that they enable to obtain the accurate geometry of the tooth gap to be milled as a rotary contour.

Test have been undertaken more recently to produce toothed gears as well as bevel gears by means of high speed metal cutting (HSC). This method uses end or profile milling which remove the tooth gaps line-by-line with very high rotation speeds and feed rates but with relatively minimal metal cutting performance (minimal chip thickness). The machining processes carried out on five-axis machine-tools in particular involve, due to the small metal cutting volume, which admittedly does not overload the spindle and the bearings of the machine-tool unduly, particularly long machining times.

It is referred to document DE 37 52 009 T3 to find a publication of the state of the art, whereas the features disclosed in this document are summed up in the preamble of claim 1. This document describes a multi-axis toothed gear hobbing machine for manufacturing bevel gears and hypoid gears, whereas a control device is provided, which can move a tool carrier and a receiving device for the workpiece simultaneously along five axes. Due to the way the tool is plunged into the workpiece, it is however necessary that the tool exhibits an external diameter which corresponds to twice the curvature radius of the longitudinal curves of a tooth flank. It is thus necessary to prepare a new tool for each new gearing geometry respectively for each new longitudinal tooth flank curve. Moreover, the machine is not designed to be used as a universal milling machine for producing other components than the special gearings.

The European patent specification EP 0 850 1.20 B1 describes a machine-tool infeed process, which reduces the wear of individual blades of a pot-shaped milling head. It is thus suggested to insert the pot-shaped milling head, whose diameter in turn must be adapted to the curvature radius of the spiral gearing to be produced, obliquely into the tooth gap during the plunging process, whereas a feed vector contains a component in a vertical direction with respect to the tooth gap base and a component in longitudinal direction of the gearing. Once the tool has reached the full depth in the workpiece, it can be either again pulled out of the workpiece directly (for profile milling, called there non-generating method) or moved in the direction of the circumference of the workpiece, in order to start with the gear hobbing in case of hob machining.

The European patent specification EP 0 690 760 B1 also describes a machine-tool infeed process, to reduce the wear on individual teeth of the utilised milling head. Here also, a feed vector is defined for the milling head, as in the patent mentioned previously, before the gear hobbing cycle properly speaking starts. It is in turn disadvantageous that the external diameter of the milling head should be adapted exactly to the arch of the gearing and as depicted at the beginning, each cutter must exhibit an individual cutting geometry so as to form a single-start or multi-start worm.

The object of the present invention is then to offer a machine-tool and a process for manufacturing gearings, in particular bevel gears or pinions, which have resolved the shortcomings of the state of the art. In particular, the machining time and in especially the major processing time of a toothed gear to be produced should be minimised. At the same time, the toothed gears should be easy to produce cost efficiently and dimensionally accurate as far as possible. To do so, the toothed gear should advantageously be milled to shape completely on a machine with one or several clamping operations. A universal milling machine should particularly advantageously find application with a tool made available according to the invention for producing the gearing.

This object is met by a machine-tool, a method and a tool according to the independent claims. The dependent claims represent preferred embodiments of the invention.

A machine-tool according to the invention, such as for instance a milling machine, contains a machine frame, a tool carrier mounted on the machine frame for receiving a tool, a drive device for rotationally driving the tool in the tool carrier about a tool axis; a receiving device mounted on the machine frame for receiving a workpiece, a first rotary drive device for generating a first relative angular movement between the tool carrier and the receiving device, in particular for rotating the workpiece and/or the receiving device about a workpiece axis, and a second rotary drive device for generating a second relative angular movement between the tool carrier and the receiving device, a translational drive device for generating a relative translation movement between the tool carrier and the receiving device along three axes, a control device, which is designed in such a way that it enables to control the relative rectilinear movements between the tool carrier and the receiving device and the relative angular movement between the tool carrier and the receiving device substantially at the same time, whereas the tool is designed as a face or face circumference milling cutter and comprises blades, which exhibit at least one partial contour of a gearing to be milled in the workpiece.

According to the invention, the external diameter of the blades is (also designated as twice the flight circle of the tool blade) greater than the distance of two adjoining tooth flanks (tooth gap), whereas the tool can be adjusted with a portion of the blades arranged in the region of the external circumference of the tool in such a way that it plunges into the workpiece with the front blades and in particular at the same time with circumferential blades in the region of the gearing to be produced.

The control device, by actuating the first and/or the second rotary drive device and/or said at least one translational drive device, then moves the tool by shifting it along the tooth flank to be machined. During this shifting movement, the distance of the tool, in particular its external circumference, formed of a plurality of blades, remains at least substantially constant with respect to the tooth gap base and/or to the tooth tip of the gearing to be milled.

for instance to produce a workpiece having a spiral gearing with the machine-tool according to the invention, the control device operates the drive device advantageously in such a way that the tool is displaced along the longitudinal tooth flank curve of the straight tooth to be produced, whereas the tilt respectively the angle of the tool axis is held constant with respect to the longitudinal tooth flank curve (generally with respect to the tooth flank). This for instance can be obtained inasmuch as the tilt of the tool axis is corrected permanently by means of the control device in particular in at least five axes, with respect to the longitudinal tooth flank curve in the transversal and/or longitudinal direction according to the geometry of the tooth flank.

The machine-tool according to the invention hence presents substantially a five-axis milling machine. It is of course also possible to provide additional axes to move the tool carrier respectively the tool and/or the receiving device translationally or rotationally for the workpiece. The machine-tool can be fitted for automated operation and include for example a tool change device, a tool magazine, a workpiece change device and/or a pallet changer. For extending the functionality, the machine-tool can also exhibit additional translational and/or rotary drive devices, such as for instance rotating or swivelling machine tables. Similarly, the machine-tool can be part of a machining centre or of a to production line, comprising additional machines, such as lathes, grinding or hardening machines.

The tool comprises at least one blade and is set up in such a way that it enables face machining or face circumference machining of the work piece. To do so, the tool can be designed as a milling head, a side milling cutter or a T-grooving cutter. Said at least one blade contains a profile formed of at least one rake face and one free face, whereas the blade profile, for producing at least one portion of a tooth gap, advantageously exhibits a first indexing blade for a flank face and a second indexing blade for at least one portion of a tooth gap base. Such an execution enables to produce during the same milling cycle the flank face as well as at least one section of the tooth gap base with the complete finished milling geometry.

Blades preferably are substantially oriented in axial direction of the tool as seen from the tool. Consequently, they do not extend vertically to the front face of the tool pointing to the workpiece. Instead of that, said blades can extend substantially parallel or angularly to the front face. Additionally, blades can also be provided along the circumferential direction of the tool respectively of individual cutters, which then extend angularly or vertically with respect to the front face of the tool.

A method according to the invention for producing a gearing on a machine-tool according to the invention comprises the following steps:
(a) Positioning the tool outside the region of the gearing to be machined;
(b) Rotationally driving the tool;
(c) Passing with the tool with a portion of the blades arranged in the region of the circumference of the tool through the region of the gearing to be produced in the workpiece with substantially simultaneous operation of all drive devices or of selected drive devices by means of the control device in such a way that at least one partial contour of a tooth flank is milled; whereas the tool is displaced along the tooth flank to be machined, with constant or substantially constant distance of the tool, in particular its external circumference, which is formed of the flight circle of the blades positioned on the external circumference, with respect to the tooth gap base and/or to the tooth gap tip;
(d) Bringing back the tool from the region of the gearing to be produced;
(e) Rotating the work piece and/or the tool around the work piece axis in a position offset by at least one tooth pitch;
(f) Repeating the steps (c)-(f) in particular in case of uninterrupted rotation of the tool, until all the tooth flanks of the workpiece are machined in the same way and the tooth gaps are completed.

The tool advantageously removes a portion of the workpiece concurrently with a portion of the front face and of the circumference face each with blades provided to that effect. It is thus however possible, to adjust the relative positioning between tool and workpiece as regards the depth direction of the gearing outside the mesh between tool and workpiece and to move the tool during chip removal milling only along the tooth flank to be machined with the constant distance aforementioned. The tool (or the workpiece or both) moves then consequently outside the mesh to the set depth, and material is subsequently removed from the workpiece by a gear hobbing movement, whereas naturally several passes of these gear hobbing movements can be carried out at several depths. Alternately, the relative positioning can be set between tool and workpiece as regards the depth direction also in the region of the gearing, in particular at one end of the tooth gap, and the tool can be moved while removing the chips along the tooth flank to be machined with the constant distance aforementioned.

The tool can be set at the beginning and during the milling cycle and in particular tracked permanently in such a way that the tool axis always remains at the same angle to the flank face to be machined. At the same time, the tool can travel along a longitudinal tooth flank curve by means in particular of all rotary and/or translational drive devices. It means that the direction vector of the advance movement of the tool extends more or less constantly tangentially with respect to the flank or a parallel thereto. In other words, the tilt of the tool axis is corrected permanently by means of the control device in particular in at least five axes, with respect to the longitudinal tooth flank curve in the transversal and/or longitudinal direction according to the geometry of the tooth flank or of the tooth gap, whereas the angle between tool axis and longitudinal tooth flank curve remains constant in the longitudinal and/or transversal direction of the longitudinal tooth flank curve. Consequently, substantially all the known face and circumference external gearings can be obtained. However, completely new gearings can also be produced with this method.

The gearing is premilled in a rough machining cycle by means of a premachining tool in such a way that the gearing adopts at least approximately the finished setpoint milling geometry, and is milled to shape in a subsequent fine machining cycle by means of a fine machining tool in such a way that the gearing adopts the finished setpoint milling geometry, whereas the steps (a)-(f) are each performed. Between the rough machining cycle and the fine machining cycle at least one additional machining cycle, in particular a milling cycle, can be interposed. A measuring cycle for checking the milled contour can be inserted between the various machining cycles. The measuring cycle may in this context be performed directly in the machine-tool for example by means of a measuring sensor or an optical measuring device (camera, laser). It is further possible to continue the fine machining cycle with further machining operations on the gearing, for instance a heat treatment and/or grinding or peeling machining. Machining can for instance be split into soft machining and hard machining, which means that after soft machining the workpiece is first of all hardened before, once hardened, it is hard machined. The last operating cycle of a workpiece once hardened is generally a fine machining, for instance by grinding, peeling or milling (smoothing).

The invention enables to use different milling tools, in particular in the external diameter and/or in the form of the blades, different milling tools inside a single tooth gap on the same machine, to produce the gearing. The invention moreover offers the opportunity to set up the tool orientation vector with accuracy in view of an optimal blade mesh between tool and workpiece. In particular with larger toothed gears, for example as of module 12, considerably shortened machining times can be achieved due to a high stock removal rate whereas milling cutters can advantageously be used with cost-effective cutting plates.

In particular during roughing, compared with the state of the art (continuing or intermittent gear hobbing, traverse milling) the milling tool can be moved along forward feed paths, which exploit optimally the capacity of the machine-tool utilised and of the tool. The forward feed path of the tool inside the tooth gap should not be limited to a single set path. Far more, a cutting division can be selected which depending on the dimensions of the tooth gap comprises several paths. The cutting division may advantageously apply to the depth as well as to the width of the tooth gap. The depth of the tooth gap to be produced can be machined in several steps, so that machining involves a plurality of planes. Several forward feed paths of the tool can be positioned close to one another on a respective plane. The number of the forward feed paths on a plane tends to be reduced decrease with increasing depth, because the width of the tooth gap is also reduced with increasing depth. The cutting division concerning the depth and the width of the tooth gap can advantageously be adjusted according to the following parameters:
Size of the module
Number of teeth influencing the form of the tooth gap
Geometry of the tool utilised, in particular the cutting width, the form of the blades, the size of the tooth pitch of the material to be chipped
Capacity of the machine-tool, for example the spindle power respectively the spindle torque, the robustness of the machine construction,
Tooth geometry, in particular the tooth height and/or the flank angle.

It is particularly advantageous to be able to use different milling tools which are optimal for the forward feed path considered. Due to the quite small chip-to-chip-times observed in modern machine-tools, in particular machining centres, the time spent on tool change is hardly noticeable compared to the time saved by the optimal tool insert. For instance, milling tools with large cutting plates can be used in the upper region of the tooth gap, which exhibit a particularly large cutting width and with which a particularly high stock removal rate can be achieved. Milling tools with smaller cutting width are preferably used in case of an increasing depth and hence decreasing width of the tooth gap.

It may be necessary in certain cases not to lay on the same plane forward feed paths which are situated close to one another, but rather at respectively different depths relative to the tooth tip or to the tooth gap base. Such is the case for example when a large portion of the material is removed from the tooth gap with a milling tool fitted with large cutting plates by means of a single milling path and then the residual material is removed with a milling tool fitted with smaller cutting plates.

Milling tools fitted with round cutting plates lend themselves particularly well for roughing the tooth gaps. The cutting plates can be produced cost efficiently in different sizes, qualities and with different so-called geometries (for instance with positive or negative rake angle). The result is hence minimal tool costs in the long run.

The forward feed paths for machining a tooth gap extend preferably in a meandering fashion, which means that the various paths adjoin one another directly without causing a rapid movement between the forward feed paths. The result can thus be forward feed paths with different process sequences, such as for instance—plunging—gear hobbing—transversal offsetting and so forth or plunging—gear hobbing—plunging—gear hobbing—offsetting—gear hobbing—plunging—gear hobbing and so forth.

When using different tools for machining a tooth gap, it is advantageous first of all to machine all the tooth gap with the matching tool. It should be noted that the time for indexing the toothed gear by one tooth pitch is generally shorter than the time for changing one tool. With particular requirements, for example in the case of very high accuracy requirements, it may prove advantageous conversely, first of all to carry out complete roughing machining for every single tooth gap before machining the following tooth gaps. A large number of tool changes should admittedly be expected, with tool changers of modern machine-tools, the chip-to-chip-time however lasts only around two to three seconds, which explains that high productivity can be achieved even with this method, since corresponding machine-tools, which are equipped with the control device according to the invention, may be used.

The forward feed paths run substantially equidistant with respect to the longitudinal direction of the tooth flank. In spiral bevel gearings, the tooth flanks are curved in longitudinal direction, moreover the tooth gap grows wider outwardly. This involves that even the forward feed paths extend mostly along a curvature and that their distance in relation to the respective milling depth decreases inwardly, i.e. towards the rotational axis. The quantity of material removed by the milling cycle accordingly to the cutting width of the milling machine hence generates an intersection at the internal end of the tooth gap earlier than at the external end. Because of this intersection at the internal end it is not necessary in numerous cases that a portion of the forward feed path extends over the whole length of the tooth gap. The result is thus at least one shorter forward feed path and consequently a minimal machining time.

Thanks to the meandering accumulation of the forward feed paths, milling is possible in co-rotating direction as well as in counter-rotating direction. In certain cases, it can indeed prove advantageous to mill either only in co-rotating direction or only in counter-rotating direction. It is thus necessary to move the milling tool, at the end of its respective forward feed path, to the starting position of the respective next forward feed path without meshing in the workpiece. This should preferably take place rapidly. The whole meandering forward feed path properly speaking is in such a case interrupted by intermediate rapid sequences.

When using milling tools with round plates, corrugated material residues remain on the tooth flank which can be detrimental to the follow-on hardening and the subsequent smoothing machining of the tooth flanks. For preventing respectively for removing these material residues a milling tool is preferably used as the last roughing tool which comprises cutting plates with straight cutting edge sections. The required tooth flank shape can be produced with such a tool with great precision. It is also possible with this tool to carry out machining in several steps relative to the depth. Alternately, milling tools with round blades, in particular in the form of plates, may also be used with which a rectilinear section connects to the round section, so that this rectilinear section can be used for removing said corrugated material residues, without requiring a tool change to do so.

Instead of straight cutting edge sections, slightly arcuated cutting edge sections can be provided for removing the corrugated material residues, in particular to achieve a ball-shaped contour of the tooth flanks.

In addition to round cutting plates, respectively general blades having a round external surface, cutting plates or plain blades may also be used for roughing, which are designed rectilinear at least along a partial section. Particularly precisely tooth flank shapes can be produced by the straight cutting edge sections. The cutting plates may for instance be trapezoidal, whereas it is particularly suitable with this embodiment when the corners have radii. The wear on the corners is thus minimised, moreover, a so-called soft cut can be achieved, which means that the mesh impact of the blades when plunging the cutting edge into the material of the work piece is minimal. The machine-tool is thus less stressed and generates fewer oscillations, which has a positive effect on the surface quality.

A cutting plate is provided in a particular embodiment for which two rectilinear sections connect to a front circular section, similar to a V with a rounded tip. Such a cutting plate connects a very high material removal performance with a high machining accuracy and a very soft cut.

Such a cutting plate can be used particularly advantageously for roughing when the orientation of the milling tool carrying the cutting plate comes into play flexibly. If for instance the tooth depth of a tooth gap is milled in five steps, the rectilinear cutting edge section of the cutting plate is meshed in the respective plane over the whole height of the tooth flank. Consequently there is the risk of blade overload or of vibrations. Due to the at least five degrees of freedom of the machine-tool it is now possible to modify the tool orientation vector flexibly. The orientation vector can be adjusted in such a way that the straight cutting edge sections are inclined backwards by an angle alpha when milling in the respective next plane from the already milled workpiece surface. In this context, corrugated material residues again remain on the tooth flank, as already explained above using the example of the round plate. These material residues can be removed in such a case with one and the same tool, inasmuch as the tool orientation vector is adjusted in such a way that the angle alpha is reset to zero. The material residue is removed in a machining step subsequent to the roughing metal cutting. When using the described milling tool, there is no need to substitute a special milling tool, which enables to save time.

The size of the angle alpha can for instance be selected according to the geometry of the milling tool as well as to the size (the module), the number of teeth and/or to the material of the toothed gear and is preferably comprised between 1° and 20°, in particular between 2° and 12°, particularly advantageously between 3° and 7°.

The quick tool change enables to utilise a separate tool for machining each flank. A milling cutter is optimised for machining the concave flank, another milling cutter is optimised for machining the convex flank. Every tool can be optimised according to the particular requirements of the corresponding tooth flank, for instance as regards the angle of a trapezoidal blade, so as to obtain an optimal milling result and a long service life.

The tool orientation vector, which is varied according to the above description, can for instance be described by the tool axis respectively the tool rotating axis, which has a predetermined orientation on the tooth flank with respect to the gearing to be produced, in particular with respect to a vertical axis, whereas the vertical can extend for instance through the normal point, is placed halfway up a tooth between tooth root (tooth gap base)and tooth tip and halfway along the tooth flank (in longitudinal direction).

According to an advantageously embodiment of the method according to the invention, the first tooth flanks of all teeth first of all are produced by milling and then the second tooth flanks arranged on the other tooth side.

A tool according to the invention exhibits a plurality of blades, whose flight circle during the rotation of the tool shows a disc surface, a cylindrical or conical surface and/or a toroidal surface. All the blades, which are arranged for machining the same tooth flank of a gearing to be produced, whereas a plurality of such blades is provided for each tooth flank, which blades are positioned on a common flight circle.

All the blades are particularly advantageously, or when using cutting plates for obtaining the cutting, all the cutting plates which are provided on the tool for machining the same tooth flank of a gearing to be produced, identical to one another.

A group of identical blades respectively of identical cutting plates can be provided per tooth flank for instance, whereas the blades are each positioned on the same flight circle.

The invention will now be described below by way of example using exemplary embodiments.

Wherein

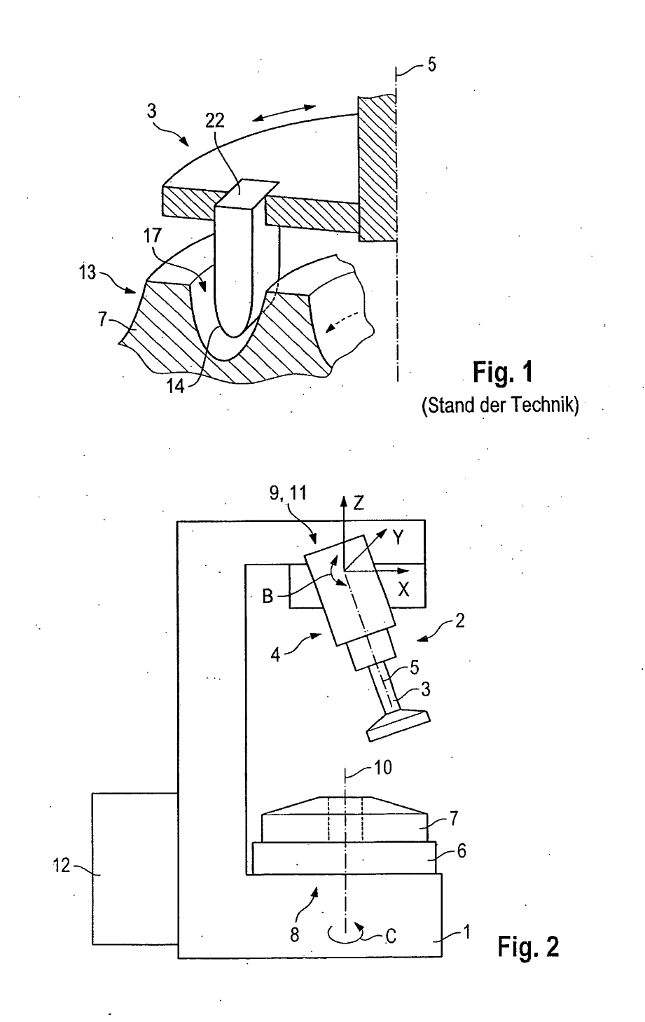

FIG. 1 is a diagrammatical partially sectional illustration of the mesh of a tool according to the known single indexing or continuous indexing process,

FIG. 2 is a diagrammatical illustration of a machine-tool according to the invention,

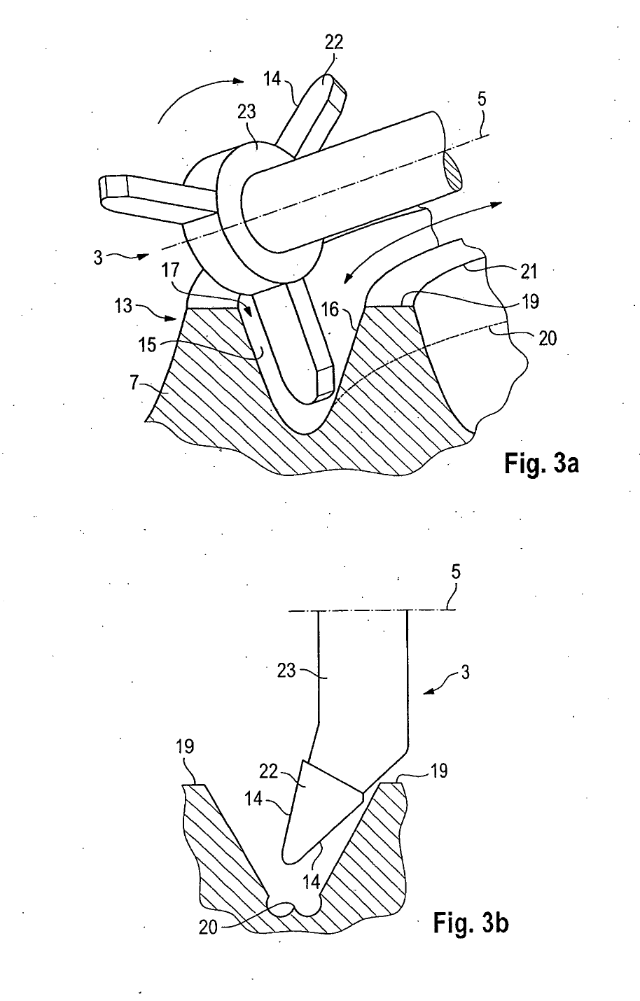

FIG. 3 is a diagrammatical illustration of the mesh of a tool in a workpiece for producing the gearing according to the method according to the invention;

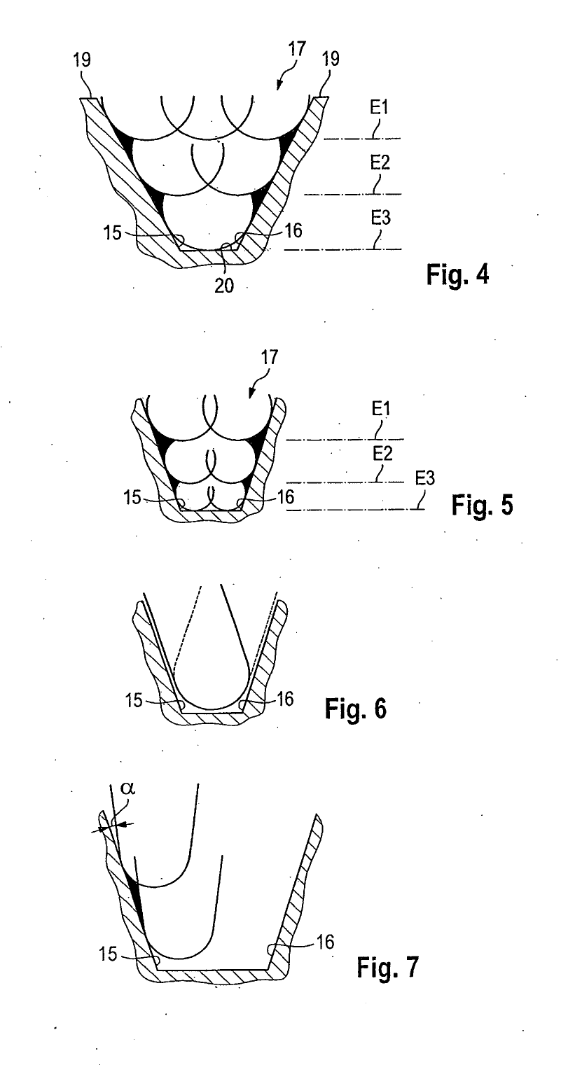

FIG. 4 is a first possibility by way of example for a cutting division with three planes E1, E2 and E3 in the depth direction of a tooth gap;

FIG. 5 shows an alternative embodiment to FIG. 4, whereas different tools are utilised for different planes;

FIG. 6 shows another possibility of cutting division when using a tool with straight, in particular parallel opposite flanks, which are connected to one another on the tool tip by a radius;

FIG. 7 shows an alternative embodiment of a cut form provided to that effect with a tool, whose blades have the form of a V with a rounded tip and for which blade overload is prevented by providing an angle alpha;

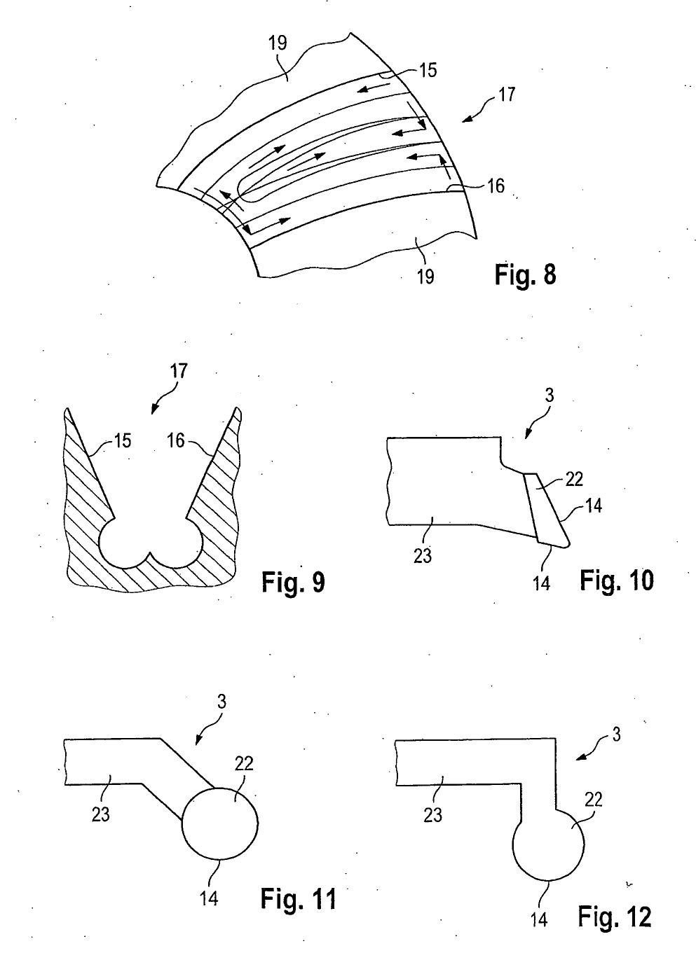

FIG. 8 is an elevation view on a tooth gap with milling paths of different lengths due to the concave form of the tooth gap;

FIG. 9 is a schematic view of a cutting path, whereas an indentation, also called protoperance, can be achieved in the region of the root of the teeth;

FIG. 10-12 show possible embodiments of a tool with cutting plates of different forms;

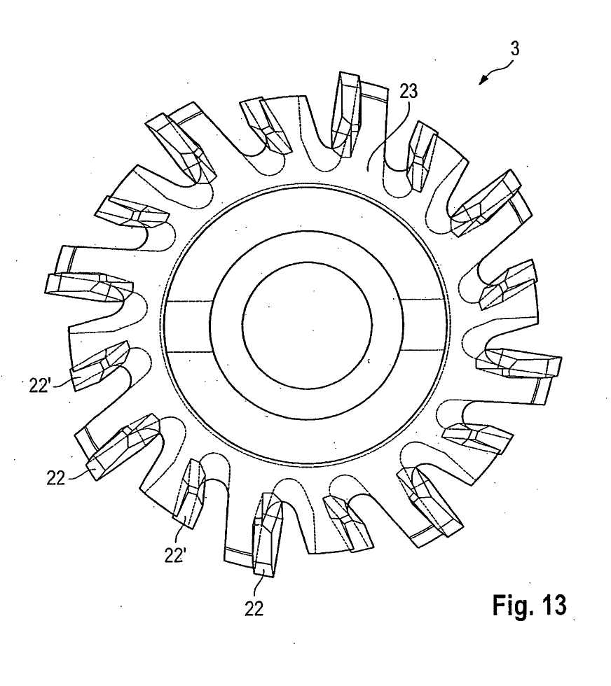

FIG. 13 is an elevation view on an advantageous embodiment of a tool.

FIG. 1 is a schematic representation of the mesh of the tool 3 into the work piece 7 for producing a gearing 13 by means of the single indexing or continuous indexing process according to the state of the art. The tool 3 is formed as a milling head and contains a plurality of cutters 22, among which only one is shown. The plurality of cutters 22 is arranged concentrically with respect to the external diameter of the tool 3, whereas the cutters 22 lie radially inside the external circumference of the tool 3. The cutters 22 extend in axial direction of the tool 3, whereas the longitudinal axes thereof run substantially parallel to the tool axis 5 of the tool 3. The cutters 22 each exhibit at least one blade 14, whereas the blades 14 are identical in the case of single indexing and in particular present the form of a tooth gap 17 to be produced. In this method, the workpiece 7 is only slightly moved and exclusively the tool 3 is rotating. Conversely, in the case of continuous indexing process the workpiece 7 and the tool 3 rotate about the rotational axis thereof relative to one another with certain regularities.

FIG. 2 is a diagrammatical illustration of the base components of a machine-tool according to the invention. Said machine comprises a machine frame 1 and a receiving device 6 mounted thereon for carrying a workpiece to be machined 7, for instance a bevel gear. A rotary drive device 8 is associated with the receiving device 6 and/or the workpiece 7 so as to rotate the workpiece 7 and/or the receiving device 6 about a workpiece axis 10 (in this instance the axis C). Moreover, the machine frame 1 carries a drive device 4 for rotationally driving a tool carrier 2 containing a tool 3 about a tool axis 5. The drive device 4 as well as the tool carrier 2 are in this instance regrouped into an angular head. The angular head is in this instance mobile relative to the workpiece along three axes X, Y, Z, vertical to one another. To that end, at least one translational drive device 11 is provided. Moreover, the tool can be twisted around the axis Y (axis B) for generating a relative angular movement between the tool axis 5 and the work piece axis 10. The machine-tool here contains consequently 5 axes which can be controlled more or less at the same time via a control device 12.

Naturally, another arrangement of the axes can be also envisioned. Additional travelling or rotational axes, by means of which the receiving device 6, the workpiece 7, the tool 3 or the tool carrier 2 can be moved relative to one another, can be provided.

Similarly, the machine-tool can be equipped with a non-illustrated tool change device which enables in particular automatic tool change between the tool carrier 2 and a non-illustrated tool magazine.

The machine-tool can also communicate with external measuring devices, so as to check the milled gearing geometry in particular during the various machining cycles.

FIG. 3 is an illustration of the mesh of a tool 3 according to the invention in a workpiece 7 for producing the gearing 13. The tool 3 is designed as a milling head in this instance and comprises a base body 23 for receiving cutters 22. The cutters 22 may for instance be designed as replaceable indexable inserts. The cutters 22 exhibit at least one blade 14. According to FIG. 3a, the cutters 22 extend in a substantially or completely level plane. The flight circle of the blades 14 hence presents a disc surface. according to FIG. 3b, the cutters 22 are tilted in the direction of the rotational axis 5 of the tool 3 (tool axis 5), with respect to such a level plane extending mostly vertical to said axis, so as to sweep a conical surface when the tool 3 is rotated. The cutters 22 are in this instance equidistant on the circumference of the base body 23 and reach here in radial direction beyond the external diameter of the base body 23.

For producing a tooth gap 17, the tool 3 is moved first of all to a starting position, in such a way that the external diameter of the tool 3 is outside the workpiece 7 relative to the tool axis 5, so as to prevent the tool 3 from colliding with the workpiece 7. At the same time or subsequently, the tool axis 5 is placed with respect to a tooth flank 15, 16 according to the tooth gap geometry to be milled. If the gearing 13 presents a arcuated flank—as seen in a section vertical to a tooth flank curve 21 through the gearing—the tool axis 5 can be set and in particular be moved in such a way that the blades 14 stand substantially always tangentially on the cambered tooth flank 15, 16.

The rotating tool 3 is then moved along the tooth flank curve 21 in feed direction onto the workpiece 7. As can be seen on FIG. 3, the tool axis 5 is arranged vertically or angularly to the tooth flank side to be removed, here 15, whereas in a arcuated gearing, in particular a bevel gear, the absolute orientation of the tool axis 5 is corrected permanently or is varied during the movement of the tool 3, so as to keep this relative orientation with respect to the tooth flank side to be removed, here 15. The tool axis 5 extends in this instance outside the tooth gap 17 to be machined currently. To do so, the tool 3 can be guided in such a way that the external circumference of the tool 3, in particular of the blades 14 respectively the contour of the flight circle of the blades 14 relative to the tool axis always runs parallel to a tooth gap base 20 and/or to the tooth tip 19. Depending on the gearing geometry, substantially all the 5 axes of the machine-tool are operated simultaneously over the control device 12 (FIG. 1) during the advance movement of the tool 3 along the tooth flank curve 21 or along a parallel to the tooth flank curve 21.

Consequently, each flank 15, 16 of the tooth gap 17 is covered individually with this method. Upon completion of the milling cycle along the whole tooth flank 15,16, the tool can be returned to the starting position and the receiving device 6 with the workpiece 7 be brought about the workpiece axis into a position offset by the tooth pitch. The following tooth flank is subsequently milled. It is also possible to machine each tooth flank 15, 16 several times consecutively for instance first of all with a roughing tool (rough machining cycle) and then with a smoothing tool (fine machining cycle), before the workpiece is indexed further by the tooth pitch. Alternately, all the tooth flanks 15, 16 of all the teeth are first of all roughed, before a smoothing tool is used, so as then to smooth and/or to grind all the tooth flanks 15, 16 of all the teeth, to achieve fine machining.

Finally, it is also possible to produce the first tooth flanks 15 by milling and by indexing the work piece by the tooth pitch, whereas in particular the orientation of the tool is kept in a first direction respectively in a first directional range when conducting the workpiece along the contour of the tooth flank to be produced, and then to change the orientation of the tool with respect to the workpiece to produce the second tooth flanks 16 by milling and by indexing the work piece, whereas mostly accordingly the orientation of the tool is kept in a second direction respectively a second directional range. It is also possible either subsequent to the milling of all the tooth flanks 15, 16 to continue with further machining steps, in particular hardening and/or fine machining, whereas fine machining for instance again in the sequence aforementioned, in the next step machining of all the tooth flanks 15 and machining of all the tooth flanks 16.

In an embodiment of the invention, in a rough machining cycle, a slit is first of all milled into the tooth gap to be produced, before both tooth flanks facing one another are produced individually in a fine machining cycle, in particular according to the previously described manufacturing sequence.

Generally, it is naturally also possible not to turn the workpiece or not to turn it only (for indexing) but to turn the tool, to trigger the relative movement of the work piece above the work piece 10 with respect to the tool 3 respectively with respect to the tool carrier 2.

Also, an additional intermediate machining cycle or several intermediate machining cycles can be provided between the rough and the fine machining cycles. The premachining, to finish machining and/or the intermediate machining cycles may completed with a single or with different tools, which deliver optimal cutting parameters for the respective machining cycle. The main processing time and hence the overall machining time are thus reduced in particular and the tool costs decreased.

FIG. 4 shows an example of a cutting division in which the roughing can be performed with one and the same tool. The tool presents for instance a plurality of circular or partially circular blades arranged over the circumference, in particular made of cutters.

In the illustrated representation, the cutting sequence may for instance be chosen in such a way that first of all plane E1 is cut free or hobbed, that is to say the first third of the depth of the tooth gap 17, then plane E2, that is to say the second third of the tooth gap depth and then plane E3, that is to say the third of the tooth gap depth. While on plane E3 a single gear hobbing along the longitudinal direction of the tooth gap, in particular simultaneously along both tooth flanks 15 and 16, is sufficient a repeated gear hobbing along the tooth flanks is necessary in the additional planes (E1, E2) situated above, here on plane E2 once along the tooth flank 15 and once along the tooth flank 16 and on plane E1 once along the tooth flank 15, once along the tooth flank 16 and once centrally between both tooth flanks 15 and 16, always in the longitudinal direction of the tooth gap.

FIG. 5 shows an additional possible cutting pattern, extensively corresponding to that of FIG. 4, however with different tools for different planes. The deeper the plane is positioned inside the tooth gap 17, the smaller the utilised blade of the tool. This enables to reduce the amount of residual material on the tooth flanks 15, 16 (coloured in black).

FIG. 6 shows an additional possible cutting division with a tool, whose blades are moved first of all along the tooth flank 15 and then along the tooth flank 16. Due to the straight sections of the blades, the material residues on the tooth flanks 15, 16 can each be removed with a forward feed path along the longitudinal direction of the tooth gap. The tool axis accordingly exhibits another orientation vector respectively another orientation with respect to the workpiece when processing every single flank.

FIG. 7 corresponds extensively to FIG. 6, the tool however is moved with its cutting edge in such a way with respect to the tooth flank 15 (subsequently also with respect to the tooth flank 16, not shown) tilted along the longitudinal direction of the tooth gap that a positive angle alpha is obtained between the blade and the tooth flank 15. This enables to obtain a high metal cutting performance without overloading the cutting edge. The material residue can be removed with the same workpiece in the last milling pass, whereas the angle alpha will then be equal to zero or almost zero degree. The illustrated cutting pattern prevents moreover the external region of the tooth flanks 15, 16 from being damaged, when the internal region of the tooth flanks 15, 16 is milled, since any impact of the tool on the external region is prevented efficiently.

In the exemplary embodiment shown on FIG. 7, the opposite blades of the tool extend obliquely to one another, so that the cutting pattern has the form of a V with a rounded tip, in particular inasmuch as a cutting plate having such an external circumference is used. The angle between the opposite blades is for instance 1° to 10°, in particular 4° to 6°, advantageously 5° less than the angle between the opposite tooth flanks 15, 16. For instance, the angle between the blades is 35° and the angle between the tooth flanks 15, 16 40°.

FIG. 8 shows a possible cutting pattern in an elevation view on a conical tooth gap 17 between two tooth tips 19. As can be seen, the cutting paths of the tool extend in longitudinal direction of the tooth gap 17, first of all along the tooth flank 15 from the outside to the inside, relative to the toothed gear, then along the tooth flank 16 from the outside to the inside, then further inside the tooth gap with a blade width distance with respect to the tooth flank 16 again from the outside to the inside, accordingly on the other side with a blade width distance along the tooth flank 15, and then in the middle region between the tooth flanks 15 and 16 again from the outside to the inside and back, whereas the whole tooth gap length is not travelled during the last movement from the outside to the inside since this is not necessary due to the narrower internal end. A short machining time can thus be obtained.

FIG. 9 again represents a tooth gap 17 with tooth flanks 15 and 16, whereas an indentation is provided in the region of the lower ends of each of the tooth flanks 15, 16. Such an indentation can be incorporated with the roughing tool according to the present invention with the method according to the invention respectively with the device according to the invention, in particular inasmuch as a round cutting edge is used. Finally, it is also possible to design a smoothing tool with the arrangement and contour of the blades according to the invention.

FIGS. 10, 11 and 12 show diagrammatical examples of embodiment for different shapes of tools 3 according to the invention, each including a base body 23 and a plurality of cutters 22, whereas according to FIG. 10 the cutters 22 exhibit such blades 14 that a first flight circle is in the form of a conical surface and a second flight circle is in the form of a disc surface. The blade, forming the conical surface, is connected via a radius with the blade 14, forming the disc.

Circular cutters 22 are provided with a corresponding round blade 14 in FIGS. 11 and 12, whereas the base body 23 according to FIG. 11 exhibits diagonally protruding arms, which carry the cutters 22, whereas conversely according to FIG. 12 the arms, which carry the cutters 22, are oriented angularly downwards.

FIG. 13 represents an exemplary embodiment for a tool 3 according to the invention, comprising two groups of cutters. In this instance, the first group of cutters is designated as 22 and the second group of cutters as 22′. As can be seen, all the cutters 22, 22 are situated on a flight circle during the rotation of the tool 3. For instance, the cutters 22′ of the second group are arranged radially further inside and further up on the base body 23 of the tool 3. the cutters 22 of the first group correspond for instance to the cutters 22 according to FIG. 10, whereas the cutters 22′ in FIG. 10 would then be arranged above the cutters 22 and further left compared thereto.

The freedom of movement according to the invention when moving the tool along the longitudinal direction of the tooth gap enables to obtain tooth flanks having a vertical crowning, even with straight blades respectively cutting edges. This vertical crowning can be achieved especially advantageously with a smoothing tool, which is designed according to the invention and is travelled forward by the teeth in several forward feed paths on different planes (hence different depths) and each with a different angle alpha with respect to a vertical median line or to a straight line along the surface of the tooth flanks. The variation of the angle alpha is for instance quite minimal and may in particular amount to fractions of a degree only.

An advantage of the method according to the invention is that the tool form is not related to the contour of the tooth flanks of the gearing to be produced and consequently gearings with different contours may be produced with one and the same tool. The flight circle radius of the tool blade can advantageously be selected freely independently of the workpiece. The tilt of the tool axis crosswise with respect to the tooth flank line can be adjusted relatively variably according to the tooth form and the blade form of the tool.

The method according to the invention could also be designated as hobbing cutting process with a tool axis tilted crosswise and in particular longitudinally with respect to the hobbing direction, whereas the tool blades may be used flexibly without having to exhibit exact flank angularity, that is to say no exact external form matching the contour of the flanks to be produced. This causes significant reduction of the tool costs, multi-faceted applicability of the machine-tool as well as reduction of the machining time of the workpieces.

According to the method of the invention, a combination of hob machining and plunge milling with flexible orientation vector of the tool axis is possible, whereas the chip-removal performance can be increased significantly with respect to conventional methods. different milling contours can be used in particular, from the side milling cutter up to (inclusive) the face inserted tooth milling cutter or pot milling cutter.

Compared to the milling of bevel gears by means of a conventional end mill, whose overall front face simultaneously plunges in each tooth gap to be generated, the tool can be designed with a substantially larger diameter according to the invention, because by tilting the tool axis crosswise to the tooth gap, in particular with angled cutting plates on the tool, only a portion of the blade always plunges into the tooth gap. Hereby, larger chip spaces may be provided in the tool. This enables to achieve larger removal of material from the workpiece with each sweep of the tool as well as a particularly heavy metal cutting. Hereby higher accuracy can again be obtained, since the tool should not sweep the workpiece so often.

The cutters advantageously exhibit such blades that they may remove material from the workpiece with the front face of the tool, with the external circumference and with the internal circumference of the cutters relative to the tool axis.

### LIST OF REFERENCE NUMERALS

1 Machine frame
2 Tool carrier
3 Tool
4 Drive device
5 Tool axis
6 Receiving device
7 Workpiece
8,9 Rotary drive device
10 Workpiece axis
11 Translational drive device
12 Control device
13 Gearing
14 Blades
15, 16 Tooth flanks
17 Tooth gap
18 Region
19 Tooth tip
20 Tooth gap base
21 Tooth flank curve
22 Cutters
23 Base body

1-15. (canceled)

16. A machine-tool, in particular a milling machine, including:
a machine stand;
a tool carrier mounted on the machine stand for receiving a tool;
a drive device for rotationally driving the tool in the tool carrier about a tool axis;
a receiving device mounted on the machine stand, for receiving a workpiece;
a first rotary drive device for generating a first relative angular movement between the tool carrier and the receiving device and a second rotary drive device for generating a second relative angular movement between the tool carrier and the receiving device;
a translational drive device for generating a relative translation movement between the tool carrier and the receiving device along three axes;
a control device, which is designed in such a way that it enables to control the relative rectilinear movements between the tool carrier and the receiving device and the relative angular movement between the tool carrier and the receiving device substantially at the same time;
wherein the tool is designed as a face or face circumference milling cutter and comprises blades, which exhibit at least one partial contour of a gearing to be milled in the work piece;
wherein the external diameter of the blades is greater than the distance of two adjoining tooth flanks tooth gap;
characterised in that:
the control device is designed, to move the tool in such a way through the region of the gearing to be machined that it is displaced globally along the tooth flank to be machined with equal or substantially equal distance with respect to the tooth gap base and/or with respect to the tooth tip of the gearing to be produced.

17. The machine-tool according to claim 16, characterised in that the machine-tool exhibits a workpiece fitted with a spiral gearing to be produced, carried by the receiving device; and
that the external diameter of the blades is larger or smaller than twice the radius of a longitudinal tooth flank curve of a spiral gearing to be produced in the workpiece, with conical tooth gaps in longitudinal direction of the tooth flanks, greater than twice the radius of the longitudinal tooth flank curve of the concave tooth flank or smaller than twice the radius of the convex tooth flank.

18. The machine-tool according to claim 16, characterised in that the tool axis is vertical or angular, in particular with an angle between 45° and 135°, in particular between 80° and 100°, to the surface to be removed, notably the tooth flank side of the workpiece.

19. The machine-tool according to claim 16, characterised in that the angle of the tool axis varies, in particular is varied permanently, with respect to a diameter of the work piece when moving along the tooth flank to be machined.

20. The machine-tool according to one of claim 16, characterised in that the tool axis runs outside the region of the gearing to be produced.

21. The machine-tool according to one of claim 16, characterised in that the blades are oriented in radial direction of the tool as seen from the tool.

22. A method for producing a gearing on a machine-tool according to claim 16, with the following steps:
(a) positioning the tool outside the region of the gearing to be produced;
(b) rotationally driving the tool;
(c) passing with the tool with a portion of the blades arranged in the region of the circumference of the tool through the work piece in the region of the gearing to be machined by controlling one or several drive devices by means of the control device in such a way that at least one partial contour of a tooth flank is milled, whereas the tool is displaced along the tooth flank to be machined with equal or substantially equal distance with respect to the tooth gap base and/or with respect to the tooth tip of the gearing to be produced;
(d) bringing back the tool from the region of the gearing to be produced;
(e) rotating the workpiece and/or the tool about the workpiece axis in a position offset by at least one tooth pitch;
(f) repeating the steps (c) to (e) until all the tooth flanks of the workpiece are machined in the same way and the tooth gaps are completed.

23. The method according to claim 22, characterised in that the steps (b) to (d) are each performed first of all for producing a first tooth flank of each tooth of the gearing to be produced and are each repeated subsequently to the production of a second tooth flank of each tooth of the gearing to be produced, before the step (e) is performed, or that the steps (b) to (e) are each performed first of all for producing a first tooth flank of each tooth of the gearing to be produced and are each repeated subsequently to the production of a second tooth flank of each tooth of the gearing to be produced.

24. The method according to claim 22, characterised in that the gearing is premilled in a rough machining cycle by means of a premachining tool in such a way, that the gearing adopts at least approximately the finished setpoint milling geometry, and is milled to shape in a subsequent fine machining cycle by means of a fine machining tool in such a way that the gearing adopts the finished setpoint milling geometry, whereas the steps (a) to (f) are each performed.

25. The method according to claim 24, characterised in that after the rough machining cycle and the fine machining cycle at least one additional machining cycle, in particular a heat treatment and/or a grinding or peeling cycle is performed on the gearing.

26. The method according to claim 22, characterised in that the depth and/or the width of the tooth gap) to be produced is split over several sections so that machining takes place at several planes in the depth and/or width.

27. The method according to claim 26, characterised in that several forward feed paths of the tool lie close to one another inside a plane relative to the tooth tip and/or the tooth gap base whereas in particular the number of the forward feed paths on a plane with increasing depth and/or width of the tooth gap.

28. The method according to claim 26, characterised in that each of the forward feed paths situated close to one another rest on different planes of different depth.

29. The method according to claim 22, characterised in that the cutting division concerning the depth and the width of the tooth gap can advantageously be adjusted according to one or several of the following parameters:
size of the module,
number of teeth influencing the form of the tooth gap,
geometry of the tool utilised, particularly, cutting width, blade form or size of the tooth pitch of the material to be chipped,
capacity of the machine-tool, for example spindle power, spindle torque or robustness of the machine construction,
tooth geometry, in particular tooth height, tooth width and/or flank angle.

30. The method according to claim 22, characterised in that different tools are used for different planes in particular the deeper the plane is positioned inside the tooth gap, the smaller the utilised cutting width of the tool, whereas conversely tools with larger cutting width are utilised in the upper region of the tooth gap.

31. The method according to claim 22, characterised in that a portion of the forward feed path does not extend over the overall length of the tooth gap during machining tooth flanks curved in longitudinal direction.

32. The method according to claim 22, characterised in that the tilt or the angle of the tool axis is held constant with respect to the longitudinal tooth flank curve.

33. The method according to claim 22, characterised in that a tool fitted with at least sectionally straight or approximately straight blades is used, and the straight sections of the blades are set with a predetermined angle alpha, which is in particular greater than 0 and smaller or equal to 5°, with respect to the tooth flanks when producing the tooth flanks, whereas the angle alpha is varied in particular when producing every single tooth flank and in particular subsequently during the following machining step for producing the tooth flank an angle alpha of 0° is adjusted.

34. A tool for use in a machine-tool according to claim 16,
with a plurality of blades, whose flight circle during the rotation of the tool shows a disc surface, a cylindrical or conical surface and/or a toroidal surface,
characterised in that
all the blades, which are arranged for machining the same tooth flank of a gearing to be produced, whereas a plurality of such blades is provided for each tooth flank, which blades are positioned on a common flight circle.

35. The tool according to claim 34, characterised in that all the blades are positioned on a common flight circle, or exclusively two or three groups with each a plurality of blades are provided, whereas all the blades of a group are positioned on the same flight circle; and/or
the blades are formed by a plurality of cutters, which are mounted in particular detachable or firmly bonded on a base body; and/or
that the cutters are designed as plates with a circular, partially circular, elliptical or partially elliptical circumference.
